(19) United States
(12) Patent Application Publication
(10) Pub. No.: US 2003/0070980 A1
(43) Pub. Date: Apr. 17, 2003

(54) Biodegradable disposable bag for cement waste

(76) Inventor: Michael Dean Ray, Ben Lomond, CA (US)

Correspondence Address: Jeffrey A. Hall, 212 Clinton Street, Santa Cruz, CA, 95062, US

(21) Appl. No.: 09/975,355

(22) Filed: Oct. 11, 2001

(51) Int. Cl. B01D 29/27

(52) U.S. Cl. 210/489; 210/499; 210/508

(57) ABSTRACT

A disposable, biodegradable bag for purifying waste liquid flow from cement disposing, installation, and construction operations, comprising, a first porous bag element and a second porous bag element, the second bag element is operably positioned within the first porous bag element. A paper filter for filtering waste liquid flow is operably positioned between the first and the second porous bag elements, and a fastening rope or strap for securing the disposable biodegradable bag to a chute of a cement dispenser or other cement dispensing mechanism is secured to the disposable and biodegradable bag.

### BACKGROUND OF THE INVENTION

### 37 C.F.R. 1.77(a)(7)

1. Field of Invention

This invention relates to disposable, biodegradable bags for storing and disposing environmental wastes, and more particularly to a disposable, biodegradable bag for removing cement waste from the dispensing chute of a cement truck, or other cement disposing means.

2. Description of the Related Art

Heretofore a wide variety of bags and containers have been proposed and developed for the storage and disposal of wastes. There have also been proposed and implemented many other types of devices and filters for the cleaning and disposal of environmental wastes. However, there is a critical need in the cement industry for a means of cleaning and eliminating waste when cement is used for construction, paving, building and the like. Currently, when a cement truck dispenses concrete through a chute or other means, or when concrete is used in other building applications, a large amount of waste fluid is typically dispensed and dumped either on the street, down drainage systems, onto the ground surrounding the construction site, or other environmentally degrading and harmful ways when the chute of the truck is cleaned after dispensing the cement or concrete.

The present invention provides a disposable, biodegradable bag for use in the cement industry, and in particular for use on the chutes of cement trucks or other cement disposing means. The bag of the present invention is extremely useful for use in cement work for it allows for the use and placement of cement without the concomitant environmental pollution from the waste runoff.

Although various type of bags and containers are known in the prior art, none are directed to a disposable, biodegradable bag which is highly efficient at cleaning and purifying waste water and liquid in cement work and construction.

The present invention provides a novel and unique bag which is highly efficient at cleaning and removing cement waste liquid flow which accompanies all cement operations and construction. Because of its high efficiency and significant positive environmental impact, the present invention solves a significant, heretofore very troublesome and costly problem in the cement and construction industry.

Accordingly, it is the primary object of this invention to provide a disposable, biodegradable bag for use in cement dispensing and construction. The bag of the present invention is also inexpensive to manufacture and use, and may be used in a wide variety of applications resulting in significant reductions in both time and labor to complete a job in an environmentally safe manner.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims

### BRIEF SUMMARY OF THE INVENTION

### 37 C.F.R. 1.77(a)(8)

The present invention is a disposable, biodegradable bag for purifying waste liquid flow from cement disposing, installation, and construction operations, comprising, a first porous bag element and a second porous bag element, the second bag element is operably positioned within the first porous bag element. A paper filter for filtering waste liquid flow is operably positioned between the first and the second porous bag elements, and a fastening rope or strap for securing the disposable biodegradable bag to a chute of a cement dispenser or other cement dispensing mechanism is secured to the disposable and biodegradable bag.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a perspective view of the disposable, biodegradable bag of the present invention secured to a cement dispensing chute, according to the invention.

FIG. 2 shows a front view of such disposable, biodegradable bag, according to the invention.

FIG. 3 shows a sectional view of such disposable, biodegradable bag, according to the invention.

### DETAILED DESCRIPTION OF THE INVENTION

### 37 C.F.R. 1.77(a)(10)

Reference will now be made in detail to the present preferred embodiments of the invention as illustrated in the accompanying drawings.

In accordance with the present invention, there is provided a disposable, biodegradable bag for purifying waste liquid flow from cement or other disposing, installation, and construction operations, comprising, a first porous bag element and a second porous bag element, the second bag element is operably positioned within the first porous bag element. A paper filter for filtering waste liquid flow is operably positioned between the first and the second porous bag elements, and a fastening rope or strap for securing the disposable biodegradable bag to a chute of a cement dispenser or other cement dispensing mechanism is secured to the disposable and biodegradable bag.

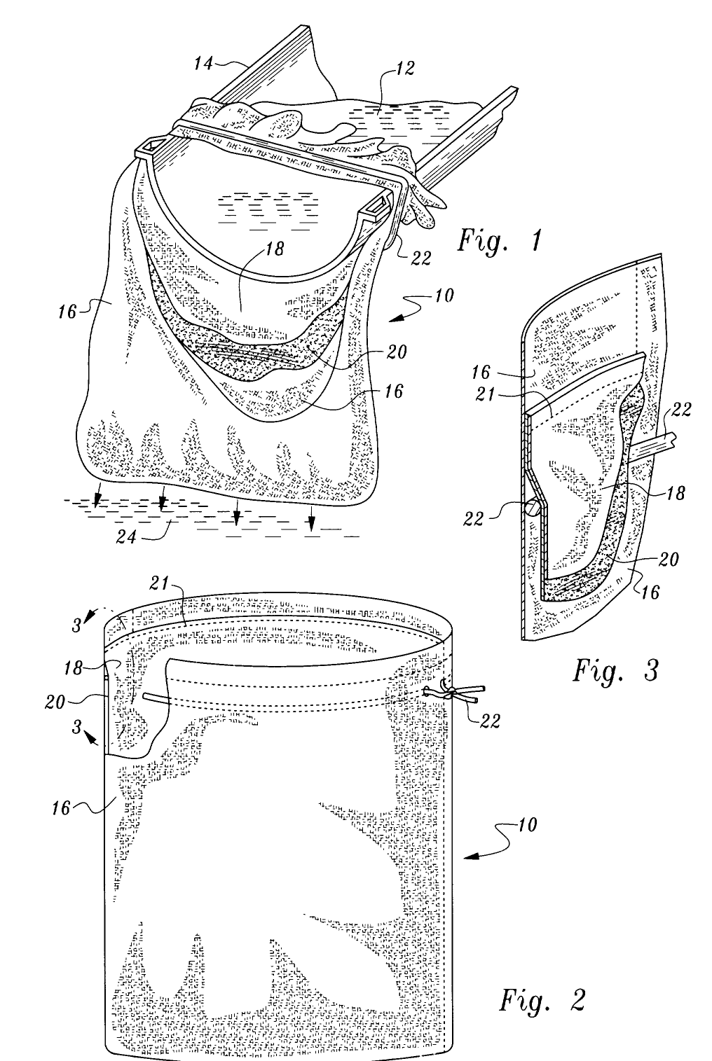

In FIG. 1, a disposable, biodegradable bag 10, for purifying waste liquid flow 12, from cement disposing, installation, and construction operations, such as cement chute 14, from a cement truck or mixer is shown. Preferably, bag 10, comprises a first porous bag element 16, composed of a porous material such as burlap, or other cloth, paper, or the like, and a second porous bag element 18, which is also composed of a porous material such as burlap or other cloth, paper, or the like. Second porous bag element 18 is preferably positioned within first porous bag element 16. A filter means, preferably a paper filter 20, for filtering waste liquid flow, is operably positioned between the first and second porous bag elements.

Fastening means, preferably a rope 22, cord, strap, wire, or other fastening means for securing disposable biodegradable bag 10, to a chute of a cement dispenser, is preferably sewn and secured by seams 21, seen in FIG. 2, or otherwise secured to bag 10, allowing bag 10 to be secured to cement dispensing chute 14, or other mechanism, and also to allow secure closure of bag 10, when use is completed.

As seen in FIG. 3, the preferred configuration of first porous bag element 16, filter 20, and second porous bag element 18, is with filter 20 sandwiched between first porous bag element 16, and second porous bag element 18. When liquid waste from cement laying, construction, installation or other operations, passes through bag 10, a highly purified and filtered water 24 results, which is non-toxic and environmentally safe.

In operation and use disposable and biodegradable bag 10, is highly efficient and cost effective to use in cement disposal, laying, construction, and other operations. Disposable and biodegradable bag 10, is simply secured to the chute 14, of a cement truck or other dispenser, and when the chute is cleaned, often requiring forty to fifty gallons of water, this waste flow of water is cleaned and filtered by passing through bag 10. When the cleaning is completed, bag 10 is removed from the chute, and rope or strap 22 tightened and tied at the top of bag 10, to ensure a secure closure. After bag 10 is drained of water and dry it may be taken to a dump or land fill for disposal.

As is evident from the above description, a wide variety of bags may be configured for may different applications from the description given herein and additional advantages and modifications will readily occur to those skilled in the art. For example, it is also contemplated that disposable and biodegradable bag 10, may be used in other building or construction environments where a convenient and quick to attach bag and filter is useful to purify waste water or other liquid flow. The invention in its broader aspects is, therefore, not limited to the specific details, representative apparatus and illustrative examples shown and described. Accordingly, departures from such details may be made without departing from the spirit or scope of the applicant's general inventive concept

What is claimed is:

1. A disposable, biodegradable bag for purifying waste liquid flow from cement disposing, installation, and construction operations, comprising:
a first porous bag element;
a second porous bag element operably positioned within said first porous bag element;
filter means for filtering waste liquid flow operably positioned between said first and said second porous bag elements; and
fastening means for securing said disposable biodegradable bag to a chute of a cement dispenser.

2. The disposable, biodegradable bag of claim 1, wherein said first porous bag element is composed of burlap.

3. The disposable, biodegradable bag of claim 1, wherein said second porous bag element is composed of burlap.

4. The disposable, biodegradable bag of claim 1, wherein said filter means is a paper filter.

5. The disposable, biodegradable bag of claim 1, wherein said fastening means is a rope fastener.

6. The disposable, biodegradable bag of claim 1, wherein said fastening means is a flexible strap.

7. A disposable, biodegradable bag for purifying waste liquid flow from cement disposing, installation, and construction operations, comprising:
a first porous bag element and a second porous bag element said second bag element being operably positioned within said first porous bag element;
a paper filter for filtering waste liquid flow operably positioned between said first and said second porous bag elements; and
fastening means for securing said disposable biodegradable bag to a chute of a cement dispenser.

8. The disposable, biodegradable bag of claim 7, wherein said first porous bag element is composed of burlap.

9. The disposable, biodegradable bag of claim 7, wherein said second porous bag element is composed of burlap.

10. The disposable, biodegradable bag of claim 7, wherein said fastening means is a rope fastener.

11. The disposable, biodegradable bag of claim 7, wherein said fastening means is a flexible strap.
